(19) United States
(12) Patent Application Publication
(10) Pub. No.: US 2022/0329595 A1
(43) Pub. Date: Oct. 13, 2022

(54) SYSTEM AND METHOD FOR SECURE VALUATION AND ACCESS OF DATA STREAMS

(71) Applicant: International Business Machines Corporation, Armonk, NY (US)

(72) Inventors: Laura Wynter, Singapore (SG); Desmond Cai, Singapore (SG); Duc Thien Nguyen, Singapore (SG); Shiau Hong Lim, Singapore (SG); Pengqian Yu, Singapore (SG)

(21) Appl. No.: 17/227,469

(22) Filed: Apr. 12, 2021

(51) Int. Cl. H04L 29/06; G06F 21/60; G06F 16/27; G06N 5/04; G06N 20/00; G06Q 30/02

(52) U.S. Cl. CPC H04L 63/10; G06F 21/602; G06F 16/27; G06N 5/04; G06N 20/00; G06Q 30/0283; G06Q 2220/12; G06Q 50/28

(57) ABSTRACT

Method and system for secure valuation and access of data streams includes encrypting access to a data stream, storing the encrypted data stream on a secure platform, determining an estimated value of the data stream based on a prediction function, determining an accuracy of the estimated value, storing the estimated value and the accuracy of the estimated value with the data stream on the secure platform and controlling access on the secure platform to the data stream. Encrypting access to the data stream may be done on a blockchain. Access on the secure platform may be controlled by a token system and a value and number of tokens for accessing the data stream is determined based on the accuracy of the estimated value. Data streams may be bundled based on the value and number of tokens for accessing the plurality of data streams determined based on the accuracy of the estimated values.

### BACKGROUND OF THE INVENTION

This disclosure is directed to computers, and computer applications, and more particularly to computer-implemented methods and systems for secure valuation, monetization and exchange of data streams.

Data streams have potential value, especially when shared, but are generally accompanied by data privacy concerns. Sources of such data streams may include inventory in a supply chain, IoT sensors, physical assets such as maritime containers, autonomous vehicles, drones, and many more, and non-physical assets such as hourly or daily prices of assets or commodities. If the value of the data is unknown and unproven, potential buyers have little incentive to participate and purchase such data streams.

A decentralized data marketplace on blockchain that enables listing of data streams from both trusted and third-party partners is known. The platform guarantees validity of streamed data by the use of geofencing to filter streams and sources and smart contracts to secure the buying and selling of streams. However, the known system does not address the problem of data valuation and assumes that buyers and sellers are able to come to a mutually agreeable price. This is challenging to accomplish in practice.

### SUMMARY OF THE INVENTION

One embodiment of a computer implemented method for secure valuation and access of data streams includes the steps of encrypting access to a data stream; storing the encrypted data stream on a secure platform; determining an estimated value of the data stream based on a prediction function; determining an accuracy of the estimated value; storing the estimated value and the accuracy of the estimated value with the data stream on the secure platform; and controlling access on the secure platform to the data stream, the estimated value and the accuracy of the estimated value. In one embodiment, encrypting access to the data stream is by blockchain. In one embodiment, encrypting access to the data stream is performed on one of a local computer or a central server computer and the secure platform storing the encrypted data stream is on a central server computer. In one embodiment, access on the secure platform is controlled by a token based system and a value and number of tokens for accessing the data stream is determined based on the accuracy of the estimated value. In one embodiment, the method includes bundling a plurality of data streams based on the value and number of tokens for accessing the plurality of data streams determined based on the accuracy of the estimated values. In one embodiment, the prediction function results in a plurality of data predictors and determining the accuracy of the estimated value includes assessing the accuracy of the data predictors and valuing the data streams based on the prediction accuracy.

A system that includes one or more processors operable to perform one or more methods described herein also may be provided.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of one embodiment of the system disclosed in this specification.

FIG. 2 is a flow diagram of one embodiment of the method disclosed in this specification.

FIG. 3 is a flow diagram of one embodiment of the method disclosed in this specification.

FIG. 4 depicts a cloud computing environment according to an embodiment of the present invention.

FIG. 5 depicts abstraction model layers according to an embodiment of the present invention.

FIG. 6 is a block diagram of an exemplary computing system suitable for implementation of the embodiments of the invention disclosed in this specification.

### DETAILED DESCRIPTION OF PREFERRED EMBODIMENTS

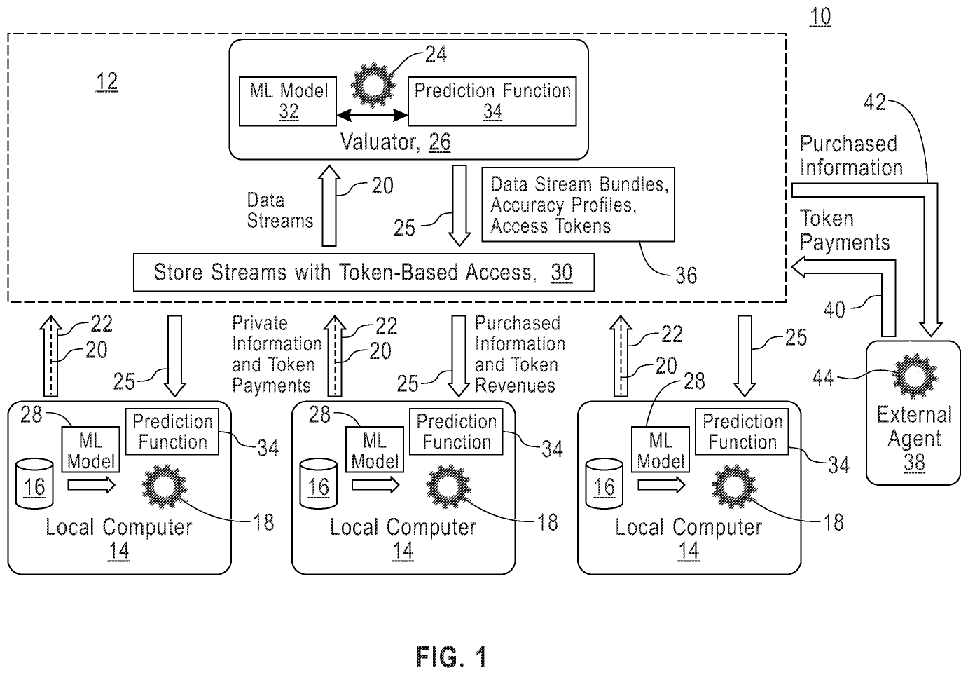

FIG. 1 is a block diagram of one embodiment, a system 10 for a secure valuation and access of data streams. In one embodiment, the system 10 includes a secure platform 12 which may be implemented on a central server or in one alternative as a cloud computing service. Users collect the data streams on local computer systems 14. The data streams may be from any data stream source such as inventory in a supply chain, IoT sensors, physical assets such as maritime containers, autonomous vehicles, drones, and many more. Each user stores their data streams in a database 16. In one embodiment, access to the data stream is encrypted. In one embodiment, access to the data stream is encrypted and stored on a blockchain. In one embodiment, blockchain with encryption 18 (which will be henceforth called “blockchain encryption”) may take place on the local computer system 14.

In order to participate in the platform, the users submit data streams 20 to the platform 12 through a secure communication link 22. The platform 12 stores and controls access to the data streams 20 in a database 30. In one embodiment, the platform 12 controls access to the data streams 20 in the database 30 using a token based system. In one embodiment, the users may submit the data stream 20 through link 22 with encryption but without blockchain. In that case, blockchain encryption 24 may be provided by the platform 12.

Blockchain 18 and 24 are both a shared, immutable ledger that facilitates the process of recording transactions and tracking the data streams in the system 10. Blockchain provides immediate, shared and completely transparent information stored on an immutable ledger that can be accessed only by permissioned network members. All network participants have access to the distributed ledger and its immutable record of transactions, With this shared ledger, transactions are recorded only once, eliminating the duplication of effort that's typical of traditional business networks. No participant can change or tamper with a transaction after it has been recorded to the shared ledger. If a transaction record includes an error, a new transaction must be added to reverse the error, and both transactions are then visible. To speed transactions, a smart contract is stored on the blockchain and is executed automatically, A smart contract can define conditions for transfer of the data streams. In one embodiment, each block has a hash pointer to the previous block and a Merkle hash tree (MHT) is employed to integrate transactions into one block in an efficient way. In a blockchain network, a large number of nodes known as miners mine a new block by running a consensus algorithm such as proof of work (POW), proof of stake (PoS) etc. Blockchain may also provide network security via PBFT consensus and immutability to make the system hack-proof. In one embodiment, Blockchain is based on Hyperledger Fabric technology. In one embodiment, Blockchain enables tokenization value using the TAS token system.

In one embodiment, blockchain may be implemented using a secure machine learning API running on homomorphic encrypted data streams with token-based access for a higher level of security. Homomorphic encryption is a method of encryption that allows any data to remain encrypted while it is being processed and manipulated. The homomorphic encryption can be implemented on the local computer system 14 or the platform 12. Homomorphic encryption enables the local computer system 14 or the provider of the platform 12 or a cloud service provider of platform 12 to apply a prediction function on the encrypted data without needing to reveal the values of the data. A homomorphic cryptosystem uses a public key to encrypt data and allows only the individual with the matching private key to access its unencrypted data and in addition uses an algebraic system to allow a variety of computations or other operations to be performed on the encrypted data. Using homomorphic encryption can secure the data that is stored on the platform 12 while also retaining the ability to calculate and search ciphered information that can later be decrypted without compromising the integrity of the data as a whole. Homomorphic encryption allows the local agent 14 or platform provider 12 to perform predictive analytics to safely analyze the data streams without putting data privacy at risk.

In one embodiment, the data streams 20 are input to a valuator module 26 on platform 12. Valuator module 26 applies a prediction function 34 to the data streams 20. In one embodiment, the prediction function 34 may be applied to the raw data streams 20 received from the user local computer system 14 without blockchain encryption. In one embodiment, the prediction function 34 may be applied by a machine learning model 28 running on local computer system 14. In another embodiment, the prediction function 34 may be applied by a machine learning model 32 running on the on platform 12. In one embodiment, the valuator module 26 determines an estimated value of the data streams 20 based on the prediction function 34.

In one embodiment, the valuator module 26 determines the accuracy of the estimated value of the data streams. In one embodiment, the estimated value and the accuracy of the estimated value are stored with the data streams 20 on the secure platform 12. In one embodiment, the secure platform 12 controls access to the data streams 20, the estimated value and the accuracy of the estimated value. In one embodiment, a value and number of tokens for accessing the data streams is determined based on the accuracy of the estimated value.

In one embodiment, the application of the prediction function 34 results in a plurality of data predictors. In one embodiment, the valuator module 26 assesses the accuracy of the data predictors and values the data streams 20 based on prediction accuracy. In one embodiment, the valuator module 26 determines an accuracy profile of the data streams 20. In one embodiment, the platform 12 prepares bundles 36 of data streams 20 based on the value and number of tokens for accessing the plurality of data streams 20 determined based on the accuracy of the estimated values.

Numerous algorithms are available for use in the prediction function. The data streams are by their nature temporal. In some cases they have a spatial component as well. Among the simplest models for time-series prediction are linear regression models, which can be used as the prediction function in this embodiment. Variants of linear regression handle spatio-temporal dependencies and lagged indicators. Other possible prediction functions include nonlinear methods including recurrent neural networks. The key is that the accuracy of the prediction determines the value and hence enables a precise valuation of each data stream.

In one embodiment, buyers 38 may view the accuracy profile of the data streams 20 and purchase one or more data stream 42 by submitting secure token payments 40. The token and data stream exchange between buyer 38 and platform 12 may be implemented on blockchain 44. The buyers may also view other characteristics of the data stream such as topic, geo-hash, potential number of other buyers or ratings before making a purchase decision. Users of local computers 14 may receive token revenues through data link 25. Users 14 may also send token payments through data link 22 and receive purchased data streams through data link 25.

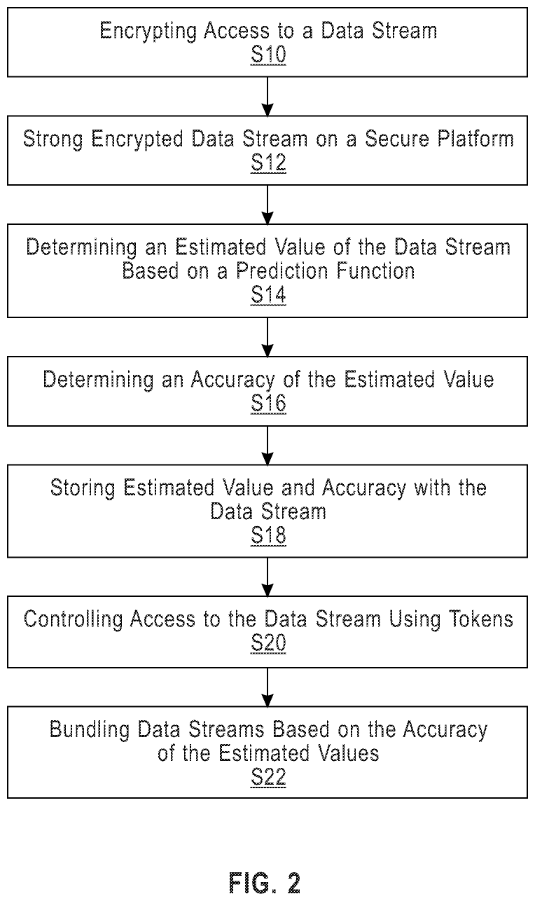

FIG. 2 is a flow diagram of one embodiment of a computer implemented method for a secure valuation and access of data streams. The method includes step S10 of encrypting access to a data stream. Step S10 may include encrypting access to the data stream is by blockchain. Step S10 may include encrypting access to the data stream on a local computer. Step S10 may include encrypting access to the data stream on a central server computer. The method may also include step S12 of storing the encrypted data stream on a secure platform. Step S12 may include storing the encrypted data stream on a central server computer. The method may also include step S14 of determining an estimated value of the data stream based on a prediction function. Step S14 may include determining the estimated value of the data stream based on a prediction function before encrypting access to a data stream. Step S14 may include determining the estimated value of the data stream based on a prediction function after encrypting access to a data stream. The method may also include step S16 of determining an accuracy of the estimated value. Step S16 may include the prediction function resulting in a plurality of data predictors, assessing the accuracy of the data predictors and valuing the data streams based on the prediction accuracy. The method may include step S18 of storing the estimated value and the accuracy of the estimated value with the data stream on the secure platform and step S20 of controlling access on the secure platform to the data stream, the estimated value and the accuracy of the estimated value. Step S20 may include controlling access on the secure platform by a token based system. Step S20 may include determining a value and number of tokens for accessing the data stream based on the accuracy of the estimated value. The method may also include step S22 of bundling a plurality of data streams based on the value and number of tokens for accessing the plurality of data streams determined based on the accuracy of the estimated values.

As noted above, prior art decentralized data marketplaces on blockchain do not address the problem of data valuation and assumes that buyers and sellers are able to come to a mutually agreeable price. This is challenging to accomplish in practice. The method and system disclosed herein differs from the known systems by the including the valuator module that assesses the usefulness of data based on predefined goals (e.g. prediction of a specific quantity). By providing a secure platform for valuation and access of data streams, the system and method disclosed herein solves a major problem in data marketplaces for streaming data. In addition, in one embodiment, a method and system for the secure valuation, monetization and exchange of data streams is disclosed. In one embodiment, the system and method includes the intrinsic valuation of information in the data streams by computer analytics, machine learning and/or other forms of artificial intelligence. In one embodiment, a valuator module on a secure computer platform evaluates the quality of information on the data streams based on prediction accuracies and computes access fees for the data streams and uses blockchain and tokens for agents to buy and sell information streams in a trusted and secure manner.

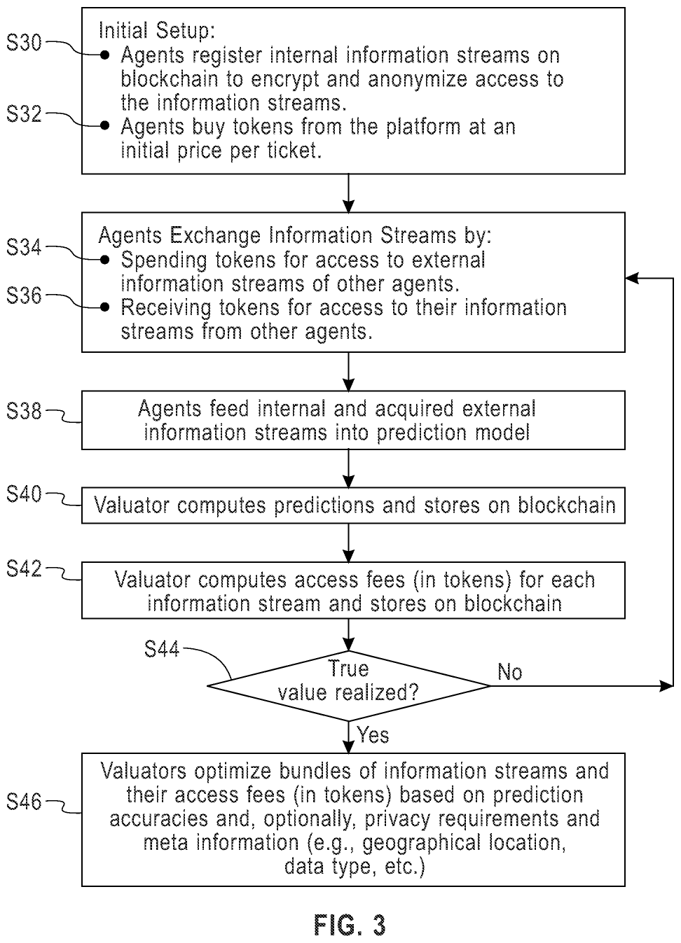

FIG. 3 is one embodiment of computer implemented method for a secure valuation, access, monetization and exchange of data streams. In a first step S30, an agent registers internal information streams on blockchain to encrypt and anonymize access to the information streams. In step S32, agents buy tokens from the platform at an initial price per token. The agents can thereafter exchange information streams by step S34 of spending tokens for access to external information streams of other agents and/or by step S36 of receiving tokens for access to their information streams from other agents. In step S38, the agents feed the internal data streams and the acquired external information data streams into a machine learning prediction model. In step S40, a valuator module computes the predictions and stores the predictions on blockchain. In step S42, the valuator module computes access fees in tokens for each information stream and stores on blockchain. In decision block S44, the valuator module analyzes the access fees and data steam and determines whether a true value of the data stream has been realized.

The true value determination is based on the accuracy of the prediction, over a recent past history of the data stream. The recent past may be on the order of one day, one week, etc. The more accurate the prediction of the data stream, the higher the marginal value of the data stream. For instance, a data stream on the price of chickens at the level of a region is high if the prediction accuracy of the price of chickens using that data stream is high. Indeed, in this case, a trader could profitably leverage the chicken price data stream and the prediction module to decide on where to source chickens and in what quantity. Similarly, a city network in which the locations of the autonomous vehicles can be accurately predicted allows a logistic company to effectively manage the fleet of vehicles and price their usage. On the other hand, a data stream on the amount of rainfall in a region, if it cannot be accurately predicted, has little value as a real-time source of information, as it does not allow effective planning in the face of rain.

When accurate prediction is possible, bundles of such data streams can have even greater value. For example, accurate prediction of a data stream on the price of livestock along with accurate prediction on the locations of delivery vehicles allows for even more effective logistic and supply chain planning.

If the valuator determines that a true value of the data stream has not been realized, NO in step S44, the method returns to step S34/S35. If the valuator determines that a true value of the data stream has been realized, YES in step S44, the valuator, in step S46, optimizes bundles of data streams and their access fees in tokens based on prediction accuracies. The bundles of data may also optionally be optimized by privacy requirements and meta information, such as geographical location, data type, etc.

In one embodiment, the system and method can be sold as a platform service to third parties to instantiate for their applications of interest. In one embodiment, the platform service can be provided on a cloud computing environment. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

In one embodiment, platform 12 can be implemented as a cloud computing model of service delivery, which enables convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

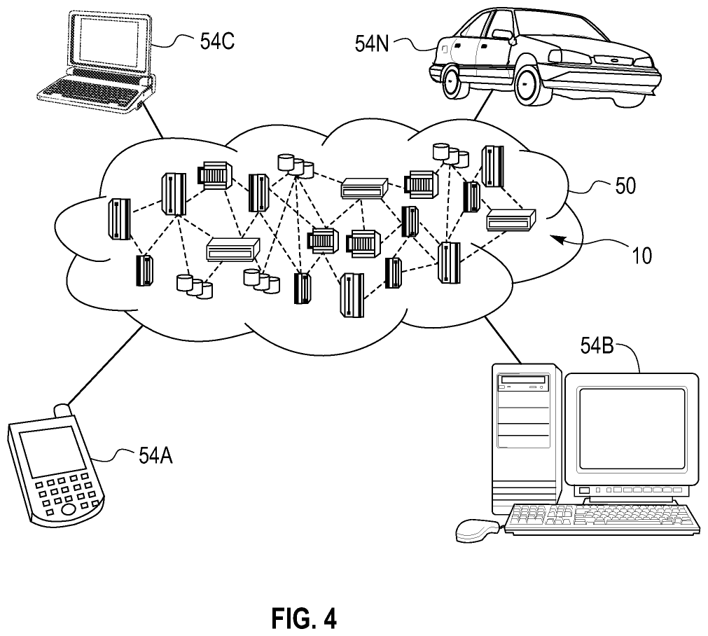

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

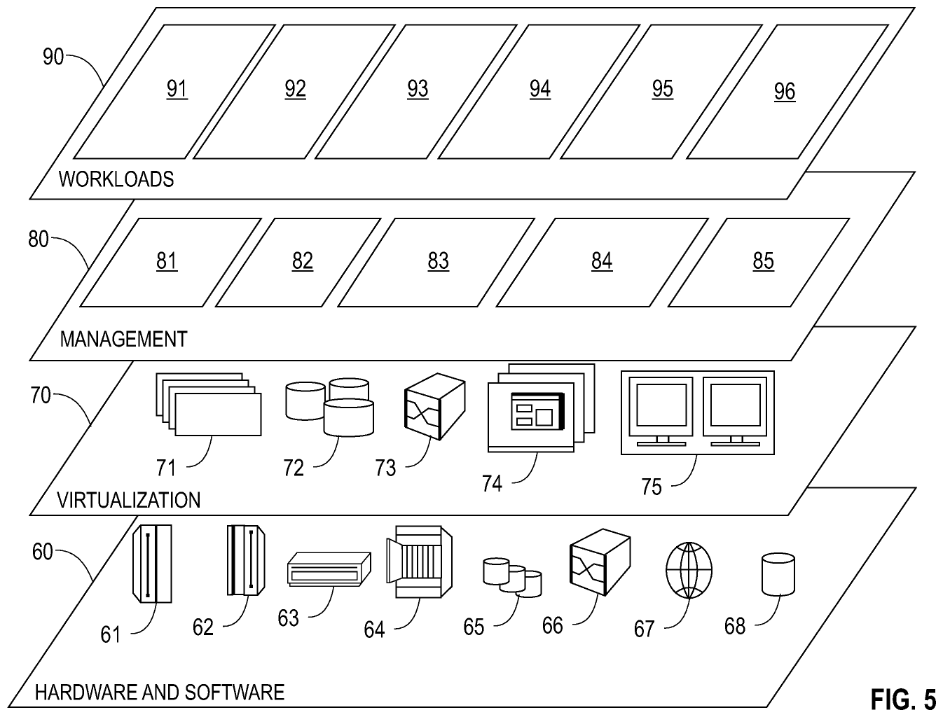

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and secure valuation and access of data streams 96.

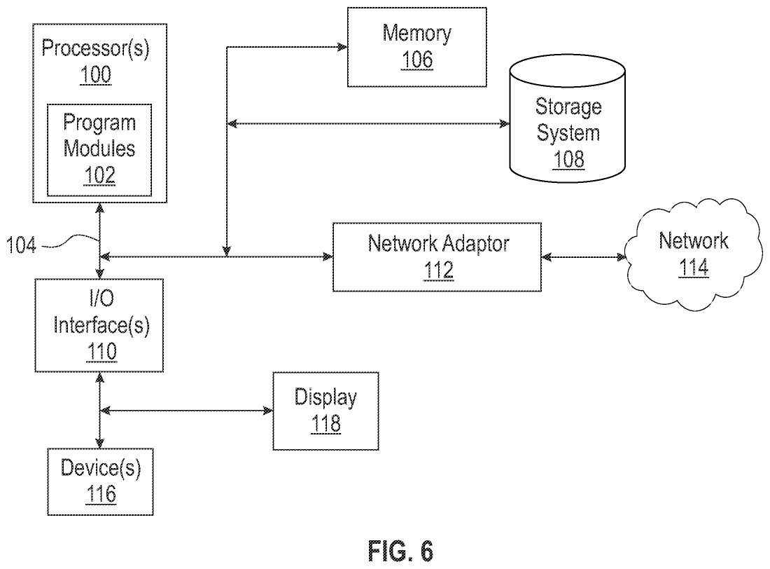

FIG. 6 illustrates a schematic of an example computer or processing system that may implement the method for secure valuation and access of data streams in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processor 100 may include a program module 102 that performs the methods described herein. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for secure valuation and access of data streams, comprising:
encrypting access to a data stream;
storing the encrypted data stream on a secure platform;
determining an estimated value of the data stream based on a prediction function;
determining an accuracy of the estimated value;
storing the estimated value and the accuracy of the estimated value with the data stream on the secure platform; and
controlling access on the secure platform to the data stream, the estimated value and the accuracy of the estimated value.

2. The computer implemented method of claim 1, wherein encrypting access to the data stream is on a blockchain.

3. The computer implemented method of claim 1, wherein encrypting access to the data stream is performed on a local computer and the secure platform storing the encrypted data stream is on a central server computer.

4. The computer implemented method of claim 1, wherein encrypting access to the data stream is performed on a central server computer and the secure platform storing the encrypted data stream is on the central server computer.

5. The computer implemented method of claim 1, wherein determining an estimated value of the data stream based on a prediction function is performed before encrypting access to a data stream.

6. The computer implemented method of claim 1, wherein determining an estimated value of the data stream based on a prediction function is performed after encrypting access to a data stream.

7. The computer implemented method of claim 1, wherein the controlling access on the secure platform is controlled by a token based system.

8. The computer implemented method of claim 7, wherein a value and number of tokens for accessing the data stream is determined based on the accuracy of the estimated value.

9. The computer implemented method of claim 1, further comprising bundling a plurality of data streams based on the value and number of tokens for accessing the plurality of data streams determined based on the accuracy of the estimated values.

10. The computer implemented method of claim 1, wherein the prediction function results in a plurality of data predictors and determining the accuracy of the estimated value comprises assessing the accuracy of the data predictors and valuing the data streams based on the prediction accuracy.

11. A computer system for secure valuation and access of data streams, comprising:
one or more computer processors;
one or more non-transitory computer-readable storage media;
program instructions, stored on the one or more non-transitory computer-readable storage media, which when implemented by the one or more processors, cause the computer system to perform the steps of:
encrypting access to a data stream;
storing the encrypted data stream on a secure platform;
determining an estimated value of the data stream based on a prediction function;
determining an accuracy of the estimated value;
storing the estimated value and the accuracy of the estimated value with the data stream on the secure platform; and
controlling access on the secure platform to the data stream, the estimated value and the accuracy of the estimated value.

12. The computer system of claim 11, wherein encrypting access to the data stream is done on a blockchain, encrypting access to the data stream is performed on one of a local computer or a central server computer and the secure platform storing the encrypted data stream is on a central server computer.

13. The computer system of claim 11, wherein the controlling access on the secure platform is controlled by a token based system and wherein a value and number of tokens for accessing the data stream is determined based on the accuracy of the estimated value.

14. The computer system of claim 11, further comprising bundling a plurality of data streams based on the value and number of tokens for accessing the plurality of data streams determined based on the accuracy of the estimated values.

15. The computer system of claim 11, wherein the prediction function results in a plurality of data predictors and determining the accuracy of the estimated value comprises assessing the accuracy of the data predictors and valuing the data streams based on the prediction accuracy.

16. A computer program product comprising:
program instructions on a computer-readable storage medium, where execution of the program instructions using a computer causes the computer to perform a method for secure valuation and access of data streams, comprising:
encrypting access to a data stream;
storing the encrypted data stream on a secure platform;
determining an estimated value of the data stream based on a prediction function;
determining an accuracy of the estimated value;
storing the estimated value and the accuracy of the estimated value with the data stream on the secure platform; and
controlling access on the secure platform to the data stream, the estimated value and the accuracy of the estimated value.

17. The computer program product of claim 16, wherein encrypting access to the data stream is done on a blockchain, encrypting access to the data stream is performed on one of a local computer or a central server computer and the secure platform storing the encrypted data stream is on a central server computer.

18. The computer program product of claim 16, wherein the controlling access on the secure platform is controlled by a token based system and wherein a value and number of tokens for accessing the data stream is determined based on the accuracy of the estimated value.

19. The computer program product of claim 16, further comprising bundling a plurality of data streams based on the value and number of tokens for accessing the plurality of data streams determined based on the accuracy of the estimated values.

20. The computer program product of claim 16, wherein the prediction function results in a plurality of data predictors and determining the accuracy of the estimated value comprises assessing the accuracy of the data predictors and valuing the data streams based on the prediction accuracy.
